(19) United States
(12) Patent Application Publication
(10) Pub. No.: US 2016/0026281 A1
(43) Pub. Date: Jan. 28, 2016

(54) SHADELESS TOUCH HAND-HELD ELECTRONIC DEVICE AND COMPUTER-EXECUTED METHOD

(71) Applicants: HannStar Display (Nanjing) Corporation, Nanjing (CN); HANNSTAR DISPLAY CORPORATION, Taipei City (TW)

(72) Inventors: Hsu-Ho WU, Taipei City (TW); Tien-Rong LU, Taipei City (TW)

(21) Appl. No.: 14/750,634

(22) Filed: Jun. 25, 2015

(30) Foreign Application Priority Data
Jul. 25, 2014 (CN) 201410360001.7
Jul. 25, 2014 (CN) 201410361853.8

(51) Int. Cl. G06F 3/041; G06F 3/0488

(52) U.S. Cl. CPC G06F 3/041; G06F 3/0488

(57) ABSTRACT

A shadeless touch hand-held electronic device, a touch-sensing cover and a computer-executed method are disclosed. The hand-held electronic device detects a data structure of electronic data stored therein hand-held electronic device and generates a corresponding link instruction. The hand-held electronic device comprises a touch-sensing cover, a display panel and a control unit. The touch-sensing cover comprises a cover and a touch-sensing structure disposed on the cover. The display panel displays information corresponding to the electronic data. The control unit coupled to the touch-sensing cover and the display panel executes following steps of: detecting at least one data structure of electronic data; linking to at least one link instruction corresponding to the data structure; enabling the detected data structure to be selected for input; and executing the link instruction linked to the selected data structure according to an input operation received by the touch-sensing structure.

### CROSS REFERENCE TO RELATED APPLICATIONS

This Non-provisional application claims priority under 35 U.S.C. §119(a) on Patent Application No(s). 201410361853.8, 201410360001.7 filed in People's Republic of China on Jul. 25, 2014, the entire contents of which are hereby incorporated by reference.

### BACKGROUND

1. Technical Field

The invention relates to a hand-held electronic device, and more particularly to a shadeless touch hand-held electronic device, a touch-sensing cover thereof, and a computer-executed method for detecting a data structure of electronic data stored in the hand-held electronic device and generating a corresponding link instruction to have a virtual button function.

2. Related Art

With the rapid development of technology and information, the requirements of people on obtaining real-time and convenient information also explosively increase, and there are increasing requirements on portable hand-held electronic devices. In addition, functional requirements of people on the hand-held electronic device, such as the functions for making a phone call or discovering the map using the hand-held electronic device, also gradually increase. Furthermore, due to the portable property of the hand-held electronic device, the user directly uses the hand-held electronic device to record various data instead of a paper notepad.

At present, most of the hand-held electronic devices have the touch input function. In general, the hand-held electronic device comprises a display panel and a touch input layer disposed outside or inside the display panel, so that the user can perform inputs on the display panel. In details, the user executes an application program, such as a text editing program, on the hand-held electronic device, so that the user can perform the inputs on the display panel, such as readily recording a telephone number, an address or the like. The input contents are transmitted to a processing unit of the hand-held electronic device in the form of electronic data. The processing unit can further detect a data structure of the electronic data, mark the contents having specific information, such as the contents of the telephone number, address or the like, and link these contents to corresponding operations. For example, U.S. Pat. No. 5,946,647 to Apple Computer, Inc. has disclosed the technology of detecting the data structure of electronic data and executes the corresponding operation, the technology has been successfully commercialized, and raises patent litigation to competitors in the same field. However, due to the advances in technology, the hand-held electronic devices are developed to be lighter, thinner, shorter and smaller. When the user performs inputting on the display panel, the user's hand greatly shields the view of the display panel, and an inadvertent touch problem usually happens. More particularly, when the user taps the link or the information displayed with the data structure, the finger further inadvertently touch other links more easily because the finger shields the view of the display panel.

In addition, in the conventional hand-held electronic device with the touch function, the touch operations are performed directly on the display panel. For example, when the information is inputted on the display panel, most of the inputs are performed through a virtual keyboard displayed on the touch display. For instance, U.S. Pat. No. 7,274,353 has disclosed the associated contents. However, when the operations are performed on the display panel, the finger may block the buttons of the virtual keyboard. More particularly, in the hand-held electronic device, such as the mobile phone having a smaller display area, the inadvertent touch problem happens more easily and frequently.

As to the process of operating the virtual keyboard, the operation of the finger on the display panel usually blocks the user's view or blocks other software objects displayed on the screen, so that the finger tip may inadvertently touch the link due to the high information density display contents. In addition, because the touch, control and operation need to be performed on the display panel of the electronic device, the phenomenon of scratching the display panel frequently occurs.

Furthermore, when the user uses the hand-held electronic device under the sun, the sunlight readability of the display panel is always a difficulty that cannot be effectively solved. Because when the user cannot clearly see the information on the display panel, the user cannot operate with two hands to effectively reply mails or the Facebook information by clicking.

In addition, a rare earth transparent touch sensing layer, such as an indium tin oxide (ITO) layer, also needs to be introduced into the touch panel to make the panel keep the transparent display performance. However, the rare earth metal indium resource is increasingly depleted, so the cost is daily increasing too. Furthermore, the electro-conductive property of the rare earth metal indium mine is also worse than that of the metal, so the touch sensitivity is restricted. In addition, it is not a good solution for the earth resource ecology and the energy-saving sustainable development to use the rare earth material to be transparent touch sensing layer in the touch panel. Furthermore, the slide distance of the finger is increased with the increase of the size of the panel, so the touch sensing layer area and the cost are increasing as well, and the efficiency and the convenience of the manual operation are also deteriorated.

Additionally, the functions of the current hand-held electronic device are developed more and more diversified, so the hand-held electronic device stores the account data of various network platforms. The hand-held electronic device may further store personal financial data when the online payment needs to be performed. Thus, more and more attention has been paid to the security issues while using the hand-held electronic device. Although the current hand-held electronic device is designed in response to the security requirement, and thus has the screen locking function, the security problem that the hand-held electronic device is lost after the screen is unlocked still cannot be solved. In other words, anyone can operate the hand-held electronic device having the screen unlocked, so the security doubt is still present.

### SUMMARY

An aspect of the invention is to provide a computer-executed method for detecting a data structure of electronic data and generating a corresponding link instruction, a shadeless touch hand-held electronic device and a touch-sensing cover of the hand-held electronic device. They can analyze the electronic data of document contents and link to the corresponding instruction to generate the corresponding operation. In addition, because the hand-held electronic device executes the input on the side opposite the panel, the user cannot shield and block a user's view or an object on the display panel upon operating to avoid an inadvertent touch problems. In addition, the user verification can be continuously performed after the screen of the hand-held electronic device being unlocked to enhance the security of operating the hand-held electronic device. The invention also provides a design around U.S. Pat. No. 5,946,647 to Apple Computer, Inc. to eliminate the doubt of patent infringement, and create for user a better use experience than the product technology of Apple Computer, Inc.

In addition, because the user can perform the touch operation on the touch-sensing cover of the hand-held electronic device, the finger cannot block the view or display information or software objects on the screen, the inadvertent touch problem upon operating the virtual keyboard can be decreased, and the link on the high information density content cannot be inadvertently touched. Besides, it is also possible to continuously perform the user verification after the screen of the hand-held electronic device being unlocked to enhance the security in operating the hand-held electronic device.

A shadeless touch hand-held electronic device is capable of detecting a data structure of electronic data stored in the hand-held electronic device and generates a corresponding link instruction. The hand-held electronic device comprises a touch-sensing cover, a display panel and a control unit. The touch-sensing cover comprises a cover and a touch-sensing structure having a plurality of detection points to be triggered. Partial or total area of the touch-sensing structure is disposed on the cover. The display panel displays information corresponding to the electronic data. The control unit is coupled to the touch-sensing cover and the display panel, and executes the steps of: computing a trigger event of the detection points; comparing the trigger event with an initiative determination condition pre-stored in the hand-held electronic device; detecting at least one data structure of electronic data if the trigger event conforms to the initiative determination condition; linking to at least one link instruction corresponding to the data structure; enabling the detected data structure to be selected for input; and executing the link instruction linked to the selected data structure according to an input received by the touch-sensing structure.

A computer-executed method is capable of detecting a data structure of electronic data and generating a corresponding link instruction. The method is executed on the hand-held electronic device. The hand-held electronic device comprises a display panel and a touch-sensing cover having multiple detection points. The method comprises the steps of: enabling a portion of the detection points of the touch-sensing cover to be triggered; computing a trigger event of the detection points; comparing the trigger event with an initiative determination condition pre-stored in the hand-held electronic device; detecting at least one data structure of electronic data if the trigger event conforms to the initiative determination condition; linking to at least one link instruction corresponding to the detected data structure; enabling the detected data structure to be selected for input; and executing the link instruction linked to the selected data structure according to an input received by a touch-sensing structure.

In one embodiment, the trigger event comprises a trigger quantity, a trigger quantity distribution, a trigger morphology (which can refer to trigger appearance), a trigger time, a trigger frequency or a trigger location (which can refer to trigger position).

In one embodiment, the control unit computes the trigger event of the detection points with an interval in a predefined time, and compares the trigger event with the initiative determination condition pre-stored in the hand-held electronic device.

In one embodiment, the control unit computes another trigger event generated by the input triggering the detection points, and compares another trigger event with an executive determination condition pre-stored in the hand-held electronic device.

In one embodiment, the area of the touch-sensing structure and the area of the display panel have a ratio relationship.

In one embodiment, the touch-sensing cover is disposed on the side of the hand-held electronic device opposite the display panel.

In one embodiment, the touch-sensing structure comprises metal mesh, metal nanowires, transparent conducting film, carbon nanotube or graphene.

In one embodiment, the control unit analyzes a grammar of the electronic data, compares the electronic data with grammars pre-stored in the hand-held electronic device, and detects the data structure of the electronic data having at least one of the grammars.

In one embodiment, the control unit analyzes a string of the electronic data, compares the electronic data with predetermined string patterns pre-stored in the hand-held electronic device, and detects the data structure of the electronic data having at least one of the predetermined string patterns.

In one embodiment, contents of the link instruction are displayed on the display panel in a menu form.

In one embodiment, the hand-held electronic device further comprises an eyeball tracking module which acquires eyeball information corresponding to the display panel.

In one embodiment, the control unit is coupled to the eyeball tracking module, receives the eyeball information and executes the steps of: analyzing the eyeball information to obtain position information corresponding to an object on the display panel; and making the display panel display a cursor at a position corresponding to the object according to the position information.

In one embodiment, a user uses one hand to operate the hand-held electronic device, and takes the touch-sensing cover to face a light source or takes the back of the display panel to face the light source.

In one embodiment, a circuit board, a battery or a memory card is further comprised between the touch-sensing cover and the display panel.

A hand-held electronic device has a shadeless touch function and a virtual keyboard function. The hand-held electronic device comprises a display panel, a touch-sensing cover and a control unit. The display panel displays images. The touch-sensing cover comprises a cover and a touch-sensing structure. The cover is disposed on the other side of the hand-held electronic device opposite the display panel. The touch-sensing structure disposed on the cover receives at least one input, and comprises a first sensing area and multiple detection points. The first sensing area corresponds to the object on the display panel, and some of the detection points are distributed in the first sensing area. The control unit coupled to the touch-sensing structure computes a trigger event of the detection points, and compares the trigger event with an initiative determination condition pre-stored in the hand-held electronic device. If the trigger event conforms to the initiative determination condition, then the touch-sensing structure receives at least one input, and positions of some of the detection points triggered by the input are located in the first sensing area, then the control unit executes a virtual button input mode.

In one embodiment, the trigger event comprises a trigger quantity, a trigger quantity distribution, a trigger morphology (which can refer to trigger appearance), a trigger time, a trigger frequency or a trigger location (which can refer to trigger position).

In one embodiment, the control unit computes the trigger event of the detection points with an interval in a predefined time, and compares the trigger event with the initiative determination condition pre-stored in the hand-held electronic device.

In one embodiment, the virtual button input mode comprises: making the display panel display a virtual keyboard, and making the touch-sensing structure generate a second sensing area corresponding to the virtual keyboard on the display panel, wherein some of the detection points are distributed in the second sensing area.

In one embodiment, the touch-sensing structure is disposed on an inner surface of the cover facing the display panel, or disposed on an outer surface of the cover away from the display panel.

In one embodiment, the hand-held electronic device further comprises an eyeball tracking module which acquires eyeball information corresponding to the display panel.

In one embodiment, the control unit is coupled to the eyeball tracking module, and the control unit receives the eyeball information, analyzes the eyeball information to obtain position information, makes the display panel display a cursor according to the position information, and makes the touch-sensing structure receive the input.

In summary, in the hand-held electronic device and the computer-executed method, the user can operate, on the touch-sensing cover, the user interface displayed on the display panel, and the method comprises: computing the trigger event of a portion of the detection points; comparing the trigger event with the initiative determination condition pre-stored in the hand-held electronic device; detecting at least one data structure of electronic data if the trigger event conforms to the initiative determination condition; linking to at least one link instruction corresponding to the detected data structure; enabling the detected data structure to be selected for input; and executing the link instruction linked to the selected data structure according to the input received by the touch-sensing structure. The detected data structure has the specific grammar or string. Therefore, the user can perform the operation on the touch-sensing cover of the hand-held electronic device, so the finger cannot block the sight, the software objects or the information displayed on screen according to the electronic data, and the link of the high information density content, which can link to the associated instruction, cannot be inadvertently touched. In addition, because the electronic device needs not to be operated on the display panel, the panel scratching can be decreased. In addition, the data structure of electronic data is detected and the detected data structure is linked to its corresponding instruction. Thus, when the user touches the information contents displayed in correspondence to the data structure on the touch-sensing cover, the corresponding instruction can be executed concurrently to generate the corresponding operation, thereby creating the smart hand-held electronic device, which truly fits the user.

Furthermore, the display panel of the hand-held electronic device displays the icon, and the touch-sensing structure of the touch-sensing cover is also defined with the first sensing area corresponding to the icon, so that the user can directly perform the operation on the touch-sensing cover of the hand-held electronic device. That is, the user can touch the first sensing area to enable the control unit to execute the virtual button input mode, and thus further operate the button for input on the touch-sensing cover. Thus, the finger cannot shade the user's view, the screen software objects or the information displayed according to the electronic data, and the link of the high information density content, which can link to the associated instruction, cannot be inadvertently touched. In addition, because the electronic device needs not to be operated on the display panel, the panel scratching can be decreased.

Also, when the user uses the hand-held electronic device under the sun, the user can use one hand to operate the hand-held electronic device with the touch-sensing cover blocking the sunlight or light source. Because the touch-sensing cover can block the sunlight, the information of the display panel can be read, and the sunlight readability of the display panel can be enhanced. In addition, new technology of the OLED or electronic paper display panel is not necessary, and the user can use one hand to perform the operation or input on the information of the display panel through the touch-sensing cover. In addition, the security in operating the hand-held electronic device and the single-hand operation convenience under the sunlight can be improved.

In addition, the hand-held electronic device can execute the other operation only under the precondition that the trigger quantity distribution or trigger morphology conforms to the initiative determination condition. Thus, when another user operates the hand-held electronic device, the operation of the hand-held electronic device cannot be operated because the trigger quantity distribution or trigger morphology does not conforms to the initiative determination condition preset by the original user. Thus, the overall security of the hand-held electronic device is enhanced.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic view showing a shadeless touch hand-held electronic device according to a first embodiment of the invention;

FIG. 2 is a schematic block diagram showing the hand-held electronic device of FIG. 1;

FIG. 3 is a schematic view showing the hand-held electronic device of FIG. 1 at another viewing angle;

FIG. 4 is a flow chart showing steps of a computer-executed method according to the first embodiment of the invention;

FIG. 5 is a schematic view showing a detection point of a touch-sensing cover of FIG. 1 being triggered;

FIGS. 6A to 6D are schematic views showing a user interface of the hand-held electronic device of FIG. 1;

FIG. 7 is a schematic view showing a user interface of the hand-held electronic device of FIG. 1 according to another implementation;

FIGS. 8A and 8B are schematic views showing a shadeless touch hand-held electronic device according to a second embodiment of the invention;

FIG. 9 is a flow chart showing steps of a computer-executed method according to the second embodiment of the invention;

FIG. 10 is a schematic view showing a user interface of the hand-held electronic device of FIG. 8A;

FIG. 11 is a flow chart showing steps of a computer-executed method according to a third embodiment of the invention;

FIG. 12A is a schematic view showing a graphic user interface displayed by the hand-held electronic device according to the third embodiment of the invention;

FIG. 12B is a schematic view showing the touch-sensing cover of FIG. 12A corresponding to the graphic user interface of FIG. 12A;

FIG. 12C is a schematic view showing an operation of the hand-held electronic device of FIG. 12A;

FIG. 13A is a schematic view showing a graphic user interface displayed on the display panel according to the third embodiment;

FIG. 13B is a schematic view showing the touch-sensing cover of FIG. 13A corresponding to the graphic user interface; and

FIG. 14 is a schematic view showing a user interface of a shadeless touch hand-held electronic device according to a fourth embodiment of the invention.

### DETAILED DESCRIPTION OF THE INVENTION

The embodiments of the invention will be apparent from the following detailed description, which proceeds with reference to the accompanying drawings, wherein the same references relate to the same elements.

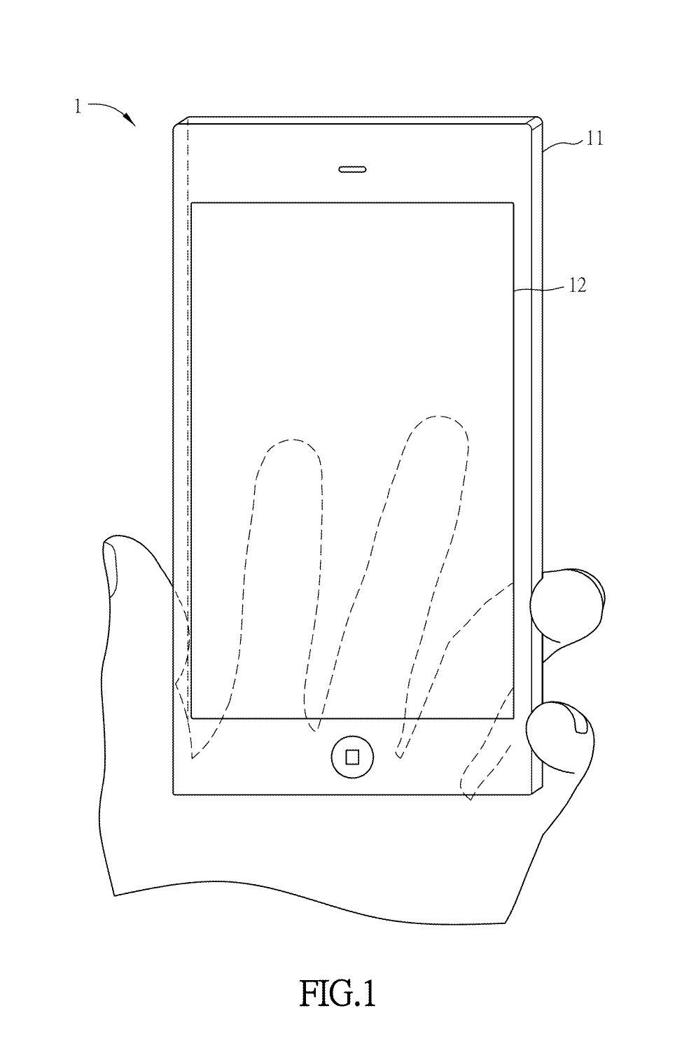

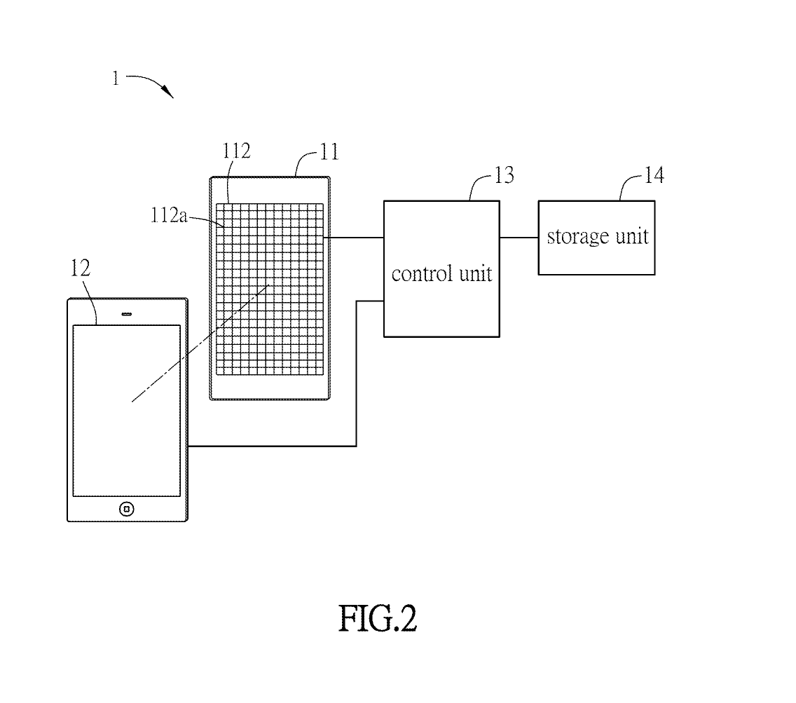

FIG. 1 is a schematic view showing a shadeless touch hand-held electronic device according to a first embodiment of the invention. FIG. 2 is a schematic block diagram showing the hand-held electronic device of FIG. 1. Referring to FIGS. 1 and 2, a hand-held electronic device 1 with the shadeless touch according to this embodiment comprises a touch-sensing cover 11, a display panel 12 and a control unit 13. The hand-held electronic device 1 of this embodiment may comprise a smart phone, a tablet computer (tablet), a personal digital assistant (PDA) or the like. In this embodiment, the smart phone is described as an example.

In this embodiment, the touch-sensing cover 11 is disposed on the other side of the hand-held electronic device 1 opposite the display panel 12. In other words, the touch-sensing cover 11 and the display panel 12 are respectively disposed on two opposite sides of the hand-held electronic device 1 (i.e., disposed on a front side and a backside of the hand-held electronic device 1). In this example embodiment, the display panel 12 is disposed on the front side of the hand-held electronic device 1, and the touch-sensing cover 11 is disposed on the backside. The touch-sensing cover 11 and the display panel 12 are coupled to the control unit 13 respectively, so that the control unit 13 can control the content information displayed on the display panel 12, and control a specific position of the touch-sensing cover 11 to be selected for input.

In details, the touch-sensing cover 11 of this embodiment provides an input interface between an electronic apparatus and a user, and the display panel 12 can display, for example, the user interface that may be a graphic user interface (GUI). Thus, as shown in FIG. 1, the user can read the contents displayed on the display panel 12 from the front side of the hand-held electronic device 1, and perform inputting from the touch-sensing cover 11 on the backside. When the user uses the hand-held electronic device 1 under the sun, the user can use one hand to operate the hand-held electronic device 1 with the touch-sensing cover 11 facing the light source to block the sunlight or light source. Because the display panel 12 is disposed with a back toward the light source, the information displayed thereon can block the sunlight through the touch-sensing cover 11, so that the sunlight readability of the display panel 12 can be improved. The user can use one hand to perform operations or inputs on the information of the display panel through the touch-sensing cover. Thus, the single-hand operation convenience of operating the hand-held electronic device 1 under the strong light source (e.g., the sunlight) can be enhanced. In addition, using the index finger or middle finger to perform the operation on the touch-sensing cover 11 is much more flexible than using the thumb in the conventional one-single-hand manipulation, and the novel and wonderful user experience of single-hand holding and multi-finger touching can be provided and created.

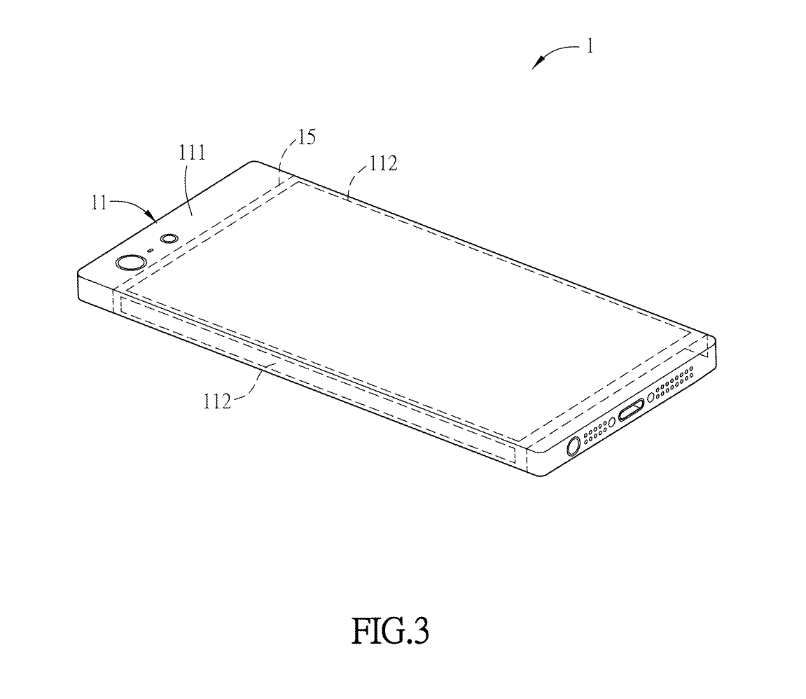

FIG. 3 is a schematic view showing the hand-held electronic device of FIG. 1 at another viewing angle. Referring also to FIG. 3, the touch-sensing cover 11 of this embodiment comprises a cover 111 and a touch-sensing structure 112. Similarly, the cover 111 is disposed on the other side of the hand-held electronic device 1 opposite the display panel 12 (i.e., a surface opposite the display surface), and partial or total area of the touch-sensing structure 112 may be disposed on the cover 111. In this embodiment, the touch-sensing structure 112 extends to two sides of the cover 111 and extends to two lateral side edges of the touch-sensing cover 11 to enlarge the area where the user executes the operating. In other embodiments, the physical key may also be replaced by the touch-sensing structure 112 of this embodiment. However, it is not limited thereto.

The touch-sensing structure 112 may be disposed on an inner surface of the cover 111 facing the display panel 12 (i.e., inside the hand-held electronic device 1), or disposed on an outer surface of the cover 111 away from the display panel 12 (i.e., hand-held electronic device 1). The touch-sensing structure 112 of this embodiment may be a capacitive touch-sensing structure and formed on the inner surface of the cover 111 facing the display panel 12, and the total area of the touch-sensing structure 112 is directly formed on the cover 111 in the described example. In different embodiments, if the touch-sensing structure 112 is disposed on an outer surface of the cover 111 away from the display panel 12, a protection layer has to be added to protect the touch-sensing structure 112. In addition, it is to be noted that the material of the cover 111 may be glass or any other material, and is one of overall members of the hand-held electronic device 1. In other words, the touch-sensing cover 11 is not an additionally added member (e.g., the protection cover of the electronic device). Thus, after the touch-sensing cover 11 being separated from the hand-held electronic device 1, the internal components of the hand-held electronic device 1, such as elements including a battery, an integrated circuit and the like, can be seen. Preferably, a circuit board, a battery or a memory card is further provided between the touch-sensing cover 11 and the display panel 12. The touch-sensing structure 112 may further comprise an transmitting circuit and a receiving circuit, and the material thereof may comprise metal mesh, metal nanowires, transparent conducting film, carbon nanotube or graphene. However, it is not limited thereto. In the example of this embodiment to be described, the touch-sensing structure 112 is a transparent conducting film, and the material of the transparent conducting film may be, for example but without limitation to, indium tin oxide (ITO), indium zinc oxide (IZO), fluorine-doped tin oxide (FTO), aluminum-doped zinc oxide (AZO), or gallium-doped zinc oxide (GZO).

In addition, it is to be noted that the material of the cover 111 may be glass or any other material, and the cover 111 is one of the overall components of the hand-held electronic device 1. In other words, the cover 111 is not an additionally added element (e.g., the protection cover of the electronic device). Thus, after the touch-sensing cover 11 being separated from the hand-held electronic device 1, the internal components of the hand-held electronic device 1, such as elements including a battery, an integrated circuit and the like, can be seen. Preferably, a circuit board, a battery or a memory card is further provided between the touch-sensing cover 11 and the display panel 12.

In different embodiments, if the touch-sensing structure 112 is disposed on the outer surface of the cover 11 away from the display panel 12, a protection layer 15 has to be additionally provided. The protection layer 15 covers the touch-sensing structure 112 to protect the touch-sensing structure 112, as shown in FIG. 3, the covering area of the protection layer 15 is larger than the laying area of the touch-sensing structure 112 to ensure that the protection layer 15 can effectively protect the touch-sensing structure 112. In addition, partial or total area of the protection layer 15 may also be disposed on the cover 11. However, it is not limited thereto.

In addition, as shown in FIG. 2, the touch-sensing structure 112 has a plurality of detection points 112a, which can be triggered to trigger a trigger event. For example, when a conductor, which may be, for example but without limitation to, a touch pen, a stylus, a user's hand or the like, touches the touch-sensing structure 112, the detection point 112a located at the touch position may be triggered to generate a signal of a trigger event, and the signal is transmitted to the control unit 13, so that the control unit 13 performs determination or analysis on the trigger event. Thus, the trigger event may be generated in correspondence with the user's gripping position when the user's hand holds the touch-sensing cover 11, or generated when the user executes the input on the touch-sensing cover 11. However, it is not limited thereto.

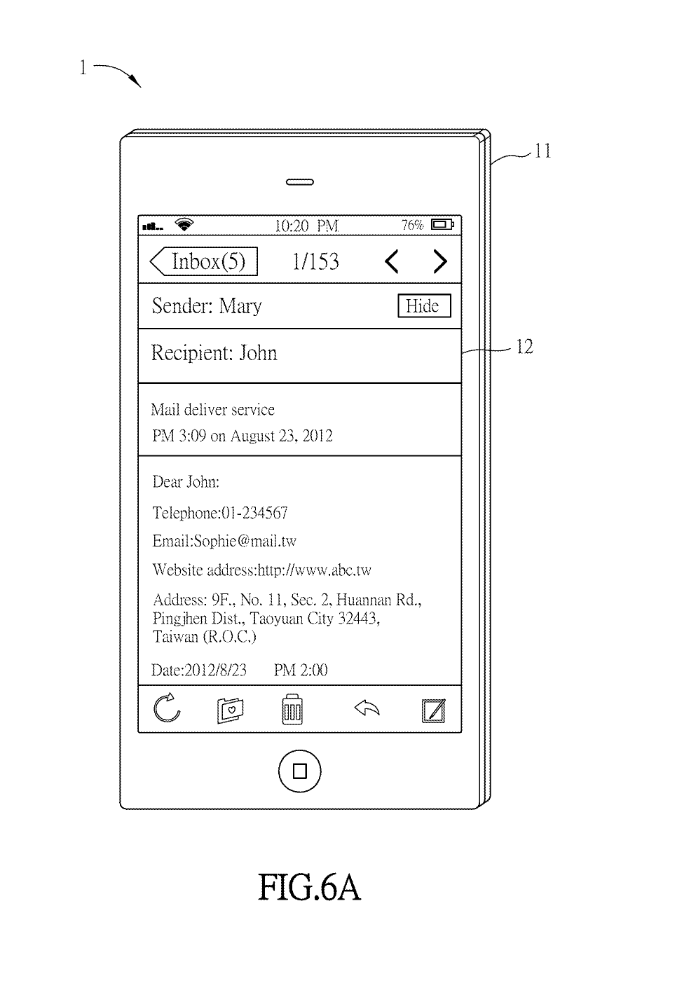

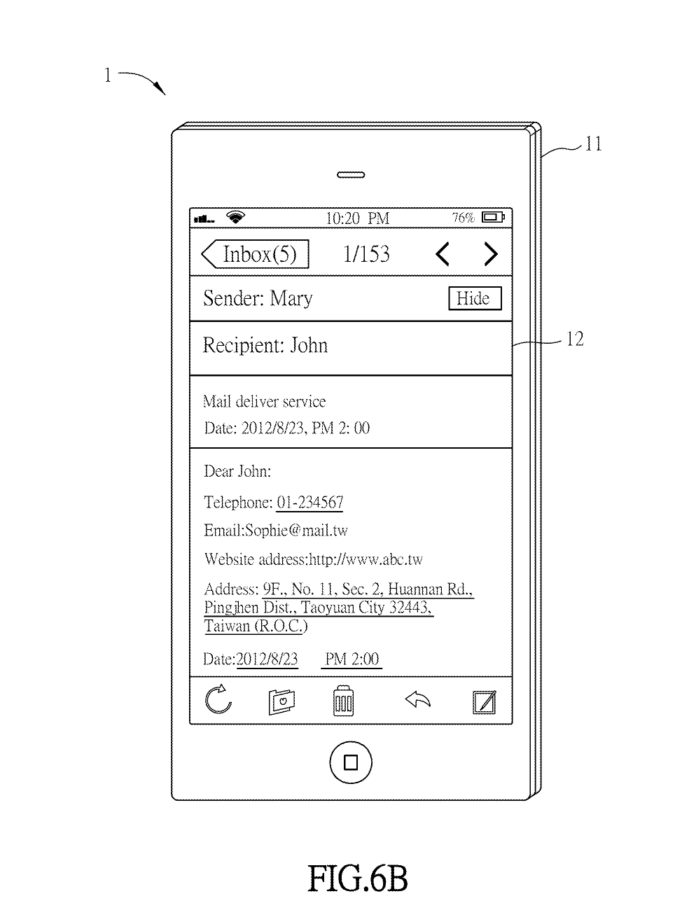

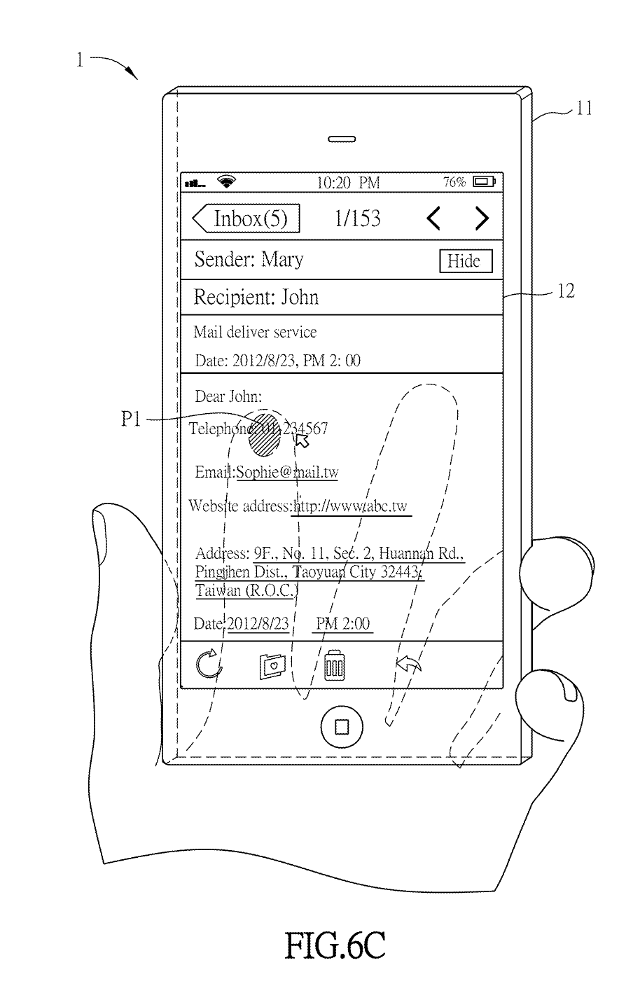

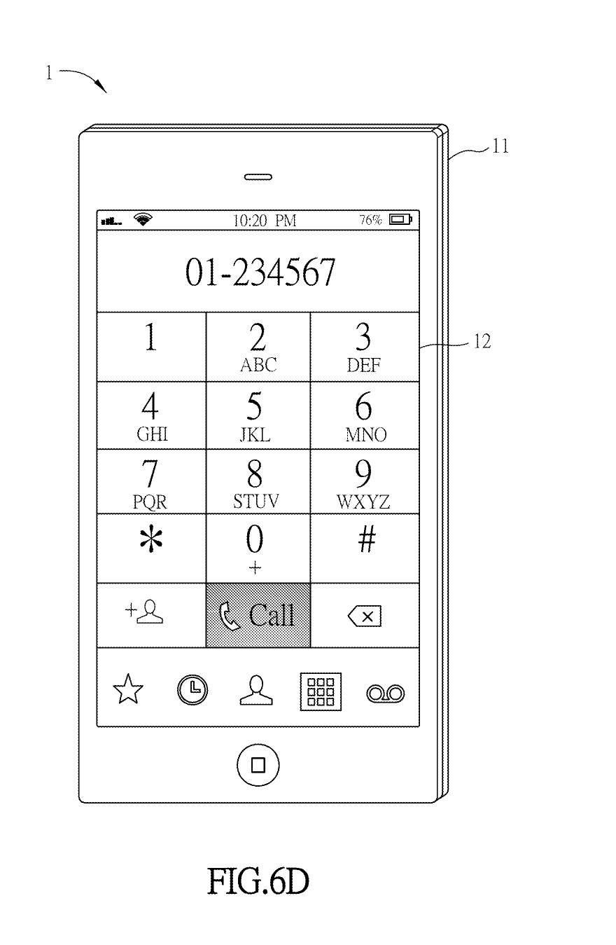

When the user executes the input on the touch-sensing cover 11, the user can operate the hand-held electronic device 1 through the touch-sensing cover 11, as shown in FIG. 1. In addition, the display panel 12 can display the corresponding operation instruction according to the user's operating gesture (or referred to as the hand gesture) to operate the user interface displayed on the display panel 12. For example, when the user's finger slides on the touch-sensing cover 11, the display panel 12 also has a corresponding cursor (e.g., arrow or hand shape) sliding at the corresponding position or path (see FIG. 6C).

In addition, in the touch-sensing cover 11 of this embodiment, the area of the touch-sensing structure 112 is smaller than the area of the display panel 12, and the area of the touch-sensing structure 112 and the area of the display panel 12 have a ratio relationship. The control unit 13 converts the touch position of the touch-sensing cover 11 into the corresponding position of the display panel 12 according to the ratio relationship.

As mentioned hereinabove, the touch-sensing cover 11 and the display panel 12 are respectively disposed on two opposite sides of the hand-held electronic device 1. Thus, when the user's hand holds the hand-held electronic device 1, the finger can be used to directly perform the touch input on the touch-sensing cover 11. The operation method is relatively instinctive and can prevent the user's hand from shielding the displayed images of the display panel 12 when the user operates the hand-held electronic device 1, and can further prevent the inadvertent touch problems. The computer-executed method of this embodiment is executed in the hand-held electronic device 1 having the touch-sensing cover 11 and the display panel 12 respectively disposed on opposite sides thereof. The computer-executed method of this embodiment is to detect the electronic data stored in the hand-held electronic device 1 and generate the corresponding link instruction, and implemented in the hand-held electronic device 1.

In details, referring to FIG. 2, the hand-held electronic device 1 of this embodiment further has a storage unit 14, which may be, for example but without limitation to, a read-only memory (ROM), a random access memory (RAM), a flash, a field-programmable gate array (FPGA) or any other memory without any restriction. The storage unit 14 of this embodiment is a random access memory (RAM) described as an example, and is coupled to the control unit 13 via a signal bus similarly.

In this embodiment, the storage unit 14 stores the operation system, the application program, the data processing program, electronic data of various formats and the like. The operation system is a program for managing the computer hardware, firmware and the software resource, and the application program may be, for example, a text editing program, an e-mail program or other programs. The data processing program of this embodiment represents the program for detecting the data structure of the electronic data and generating the corresponding link instruction. In this embodiment, the control unit 13 is a central processing unit (CPU), for example, and the control unit 13 executes these programs.

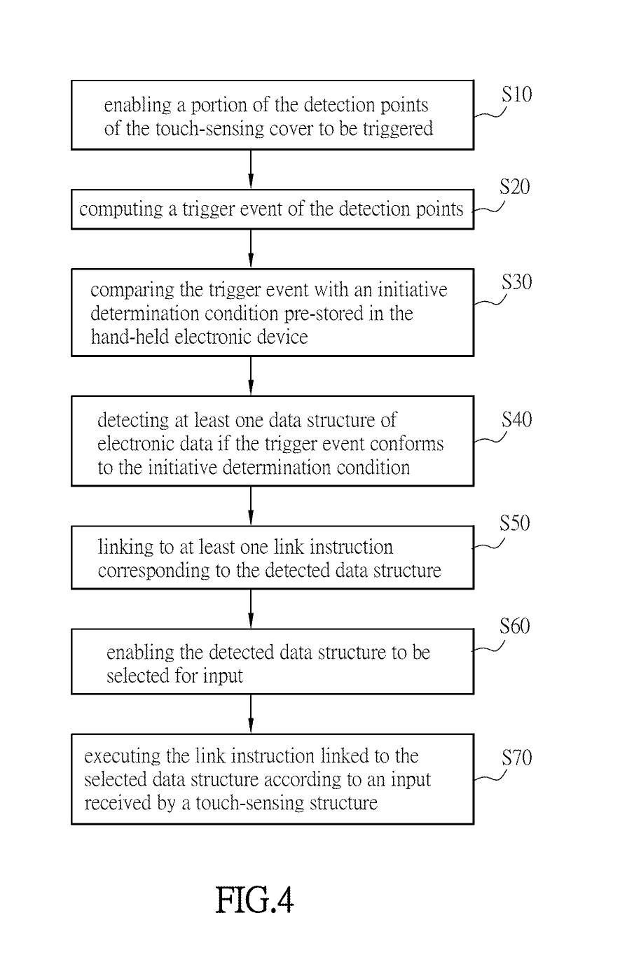

FIG. 4 is a flow chart showing steps of a computer-executed method according to the first embodiment of the invention. Referring to FIG. 4, the computer-executed method of this embodiment is to detect the data structure of electronic data and generate the corresponding link instruction, and executed by the hand-held electronic device 1 to execute the following steps of: enabling a portion of the detection points of the touch-sensing cover to be triggered (step S10); computing a trigger event of the portion of the detection points (step S20); comparing the trigger event with an initiative determination condition pre-stored in the hand-held electronic device (or referred to as a portable electronic device) (step S30); detecting at least one data structure of electronic data if the trigger event conforms to the initiative determination condition (step S40); linking to at least one link instruction corresponding to the detected data structure (step S50); enabling the detected data structure to be selected for input (step S60); and executing the link instruction linked to the selected data structure according to an input received by the touch-sensing structure (step S70).

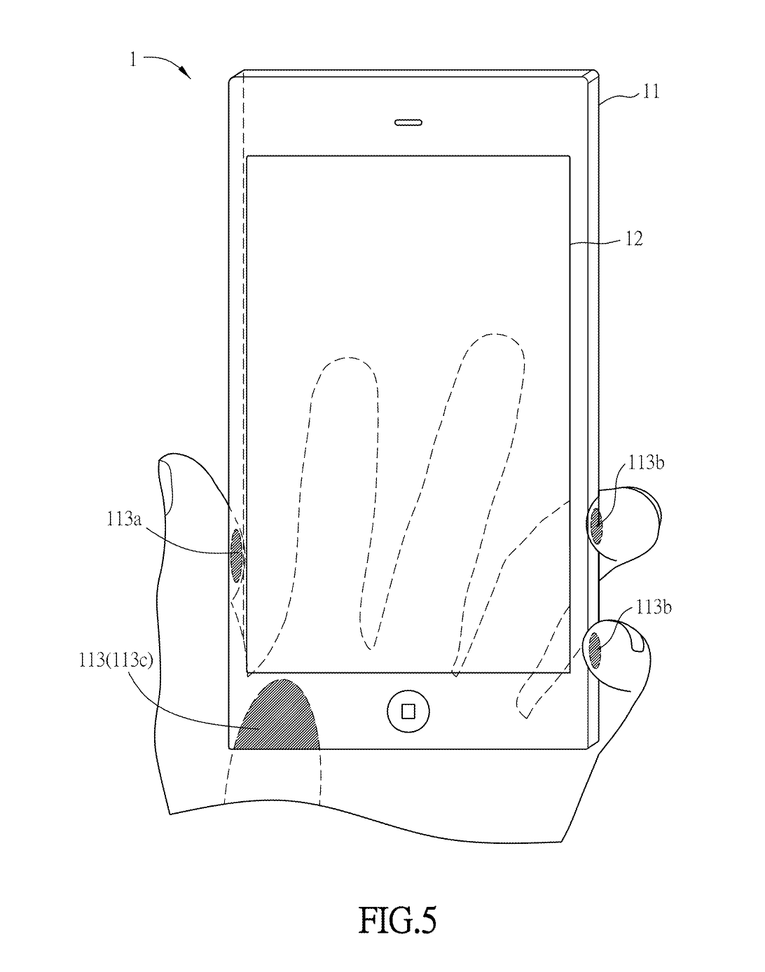

Referring to FIGS. 1, 2 and 4 concurrently, the condition that a portion of the detection points 112a of the touch-sensing cover 11 is triggered in the step S10 represents that the user touches the touch-sensing cover 11, and thus the detection point 112a touched by the user is triggered, and the touch signal is correspondingly generated. By coupling the control unit 13 to the touch-sensing cover 11, the control unit 13 can receive the touch signal, and compute the trigger event of the triggered detection point 112a (step S20). The trigger event may be a trigger quantity, a trigger quantity distribution, a trigger morphology (which can refer to trigger appearance), a trigger time, a trigger frequency or a trigger location (which can refer to trigger position). Referring to FIG. 5, FIG. 5 is a schematic view showing a detection point of a touch-sensing cover of FIG. 1 being triggered. In details, when the user operates the hand-held electronic device 1, the user can set the user's holding habit in advance. That is, the control unit 13 can analyze the trigger quantity, the trigger quantity distribution, the trigger morphology, the trigger time, the trigger frequency or the trigger location of the detection point 112a triggered by the user who is operating the setting interface, and defining it as the initiative determination condition stored to the storage unit 14. In other words, the holding position where the user is operating the hand-held electronic device 1 is defined as the initiative determination condition. For example, the control unit 13 can analyze the position of the triggered detection point 112a, and define the adjacent detection points, having the trigger quantity larger than a predetermined value, as a trigger region 113 (see FIG. 5). The trigger quantity distribution of the detection points 112a of this embodiment has one trigger region 113a on one side of the touch-sensing cover 11, two trigger regions 113b on the other side of the touch-sensing cover 11, and one trigger region 113c on one side of the touch-sensing cover 11 opposite the display panel 12. In other words, the trigger quantity distribution of this embodiment represents the distribution positions of each trigger region 113. The trigger morphology of this embodiment is the shape of each trigger region 113 (i.e., the shape of each of the trigger regions 113a, 113b and 113c). In other embodiments, the trigger time longer than a predetermined time may also be defined as the initiative determination condition. So, the trigger time longer than the predetermined time may be regarded as the effective input. Alternatively, a predetermined trigger frequency may be defined as the initiative determination condition and may be regarded as the password similar to the concept of Morse code. The subsequent input cannot be performed until the trigger frequency conforms to the initiative determination condition.

It is to be additionally described that if the trigger morphology is in the form of multiple surface contacts, then it is directly determined not to conform to the initiative determination condition. Herein, multiple surface contacts represent two or more than two surface contacts. In this embodiment, the “surface contact” represents that the diameter of the single trigger region formed when the user touches the touch-sensing structure 112 of the touch-sensing cover 11 is larger than or equal to 7 millimeters, or that the longest distance from one contact edge to the other contact edge is larger than or equal to 7 millimeters. The above-mentioned contents are based on the following assumption. If the user does not perform the touch operation on the hand-held electronic device 1, but only simply holds the hand-held electronic device 1, the trigger morphology of multiple surface contacts is easily generated. Thus, the trigger event is directly determined not to conform to the initiative determination condition.

In this embodiment, after the setting is completed and when a conductor (e.g., user's hand) touches the touch-sensing cover 11 (step S10), the control unit 13 can compute the trigger quantity distribution or trigger morphology of the triggered detection point 112a (step S20) after receiving the touch signal, as mentioned hereinabove, and compare the computed trigger quantity distribution or trigger morphology with the initiative determination condition pre-stored in the hand-held electronic device (or referred to as the portable electronic device) (step S30). As mentioned hereinabove, the initiative determination condition of this embodiment is the holding position where the user operates the hand-held electronic device 1.

Next, if the trigger quantity distribution or trigger morphology conforms to the initiative determination condition, then at least one data structure of electronic data is detected (step S40). In other words, only in the precondition that the trigger quantity distribution or trigger morphology conforms to the initiative determination condition, the control unit 13 can execute the other operations (i.e., detect at least one data structure of electronic data), and the operation of reading the contents of the e-mail is described as an example in this embodiment. Thus, when another user operates the hand-held electronic device 1, the operation of the hand-held electronic device 1 cannot be continued because the trigger quantity distribution or trigger morphology is not match that of the initiative determination condition preset by the original user. Thus, the overall security of the hand-held electronic device 1 is enhanced. Preferably, the control unit 13 can compute the trigger quantity distribution or trigger morphology of the detection point 112a with an interval in a predefined time, and compare it with the initiative determination condition to further enhance the security in using the hand-held electronic device 1.

When the trigger event triggered by the user holding the hand-held electronic device 1 conforms to the initiative determination condition, the document of the e-mail is transmitted to the control unit 13 in the form of electronic data. Next, the control unit 13 executes the rear section of the step S40 to the step S70. In other embodiments, the contents of other documents may also be read. However, it is not limited thereto.

Descriptions will be continued according to the user interface displayed by the hand-held electronic device 1. FIGS. 6A to 6D are schematic views showing a user interface of the hand-held electronic device of FIG. 1. For the sake of the conciseness in the drawings, the portion where the user holds the hand-held electronic device 1 will be emitted. Referring first to FIG. 6A, the display panel 12 displays the information corresponding to the electronic data (the contents of the e-mail document in this embodiment). Referring also to FIGS. 2 and 4 concurrently, at least one data structure of electronic data is detected in the step S40, and the control unit 13 can analyze the grammar or string of the electronic data and compare the grammar or string of the electronic data with the grammars or predetermined string patterns pre-stored in the hand-held electronic device to detect the data structure of the electronic data having these grammars or these predetermined strings. In details, the storage unit 14 stores a grammar specification and a string library, the grammar specification has the grammars, and the string library has the predetermined string patterns. In addition, the storage unit 14 concurrently stores the corresponding link instruction corresponding to each grammar and each predetermined string pattern.

After the control unit 13 receives the electronic data (the document of the e-mail), the electronic data in the grammar specification may be compared, and the data structure having the specific grammar may be screened from the electronic data. In this embodiment, the data structure may also be referred to as the detected data structure, that is, the data structure detected as having the specific grammar or predetermined string pattern. The specific grammar of this embodiment comprises a telephone number, an address, an e-mail address, a uniform resource location (URL) or the similar grammar. Then, the detected data structure having the specific grammar is linked to the corresponding link instruction (step S50), so that the corresponding operation is generated. In addition, the search or comparison can be performed on the contents of the electronic data in the string library through the string search function to screen the data structure having the predetermined string pattern, and the predetermined string pattern may also be the telephone number, address, date or time or the similar string pattern. For example, if the data structure having the grammar or string pattern of the telephone number is detected, then it can be linked to the link instruction of making a phone call, or linked to the link instruction of executing the phonebook application program. If the data structure having the address grammar is detected, then it can be linked to the link instruction of executing the electronic map application program. If the data structure having the date or time string pattern is detected, then it can be linked to the link instruction of executing the calendar application program.

Next, in the step S60, the control unit 13 can enable the detected data structure to be selected for input. In this embodiment, the control unit 13 can enable a portion of the detection points 112a corresponding to the detected data structure to be selected for input. In other words, the control unit 13 can enable the region of the touch-sensing structure 112 corresponding to the detected data structure to be selected for input. In other embodiments, the position to be selected for input is not particularly restricted. In details, the control unit 13 can mark the pointer corresponding to the detected data structure having the specific grammar or predetermined string pattern in the data of the real-time displayed on the display panel 12, and correspondingly transmit the data of the associated position to the display panel 12 and the touch-sensing structure 112 of the touch-sensing cover 11. Thus, the information (i.e., telephone number, e-mail address, address, date, time) of the detected data structure displayed on the display panel 12 is highlighted, as shown in FIG. 6B. In addition, the data structure detected as having the specific grammar or string in the corresponding region on the touch-sensing structure 112 (i.e., the detection point 112a corresponding to the marked portion) is enabled to be inputted by way of touch, as shown in FIG. 6C. In other words, the data structure detected as having the specific grammar or string can form a link, so that the user can touch the link on the touch-sensing cover 11, and thus select the data structure having the specific grammar or string for input. In this embodiment, the touch input is performed in the region of the touch-sensing cover 11 corresponding to the telephone number, for example.

In details, in step S70, the user can perform the input on the touch-sensing cover 11. In this embodiment, the position of the input is the detection point 112a corresponding to the detected data structure. Meanwhile, the detection point 112a is triggered to generate the trigger event, which is transmitted to the control unit 13. As mentioned hereinabove, the trigger event may be the trigger quantity, the trigger quantity distribution, the trigger morphology, the trigger time, the trigger frequency or the trigger location. In this embodiment, the trigger quantity is described as an example. In this embodiment, the control unit 13 can compute the trigger quantity of the detection point 112a triggered by the input, and compare the trigger quantity with the executive determination condition pre-stored in the hand-held electronic device. In details, the executive determination condition may be that the number of times of triggering the detection point 112a falls within a predetermined range (i.e., the trigger quantity falls within the predetermined range), and this condition may be defined as the meaningful input. The control unit 13 can execute the link instruction linked to the selected data structure according to the input. The predetermined range may be defined as the range of the trigger quantity generated when the user's preferred finger operates to trigger the detection point 112a. The setting of the executive determination condition can decrease the conditions that other conductors inadvertently touch the touch-sensing cover 1.

As shown in FIG. 6C, this embodiment is described in an example of selecting the data structure having the telephone number grammar or string, and the instruction linked to the data structure having the telephone number grammar or string is an instruction of making a phone call. Thus, when the user touches the position P1 corresponding to the telephone number on the touch-sensing cover 11 (the user's finger is curved to touch the position P1, as shown in FIG. 6C), the cursor may be displayed at the position P1, and the telephone number is selected for input. At this time, the data structure having the telephone number grammar or string is selected, and the control unit 13 executes the instruction of making a phone call to execute the application program for making a phone call according to the telephone number, as shown in FIG. 6D.

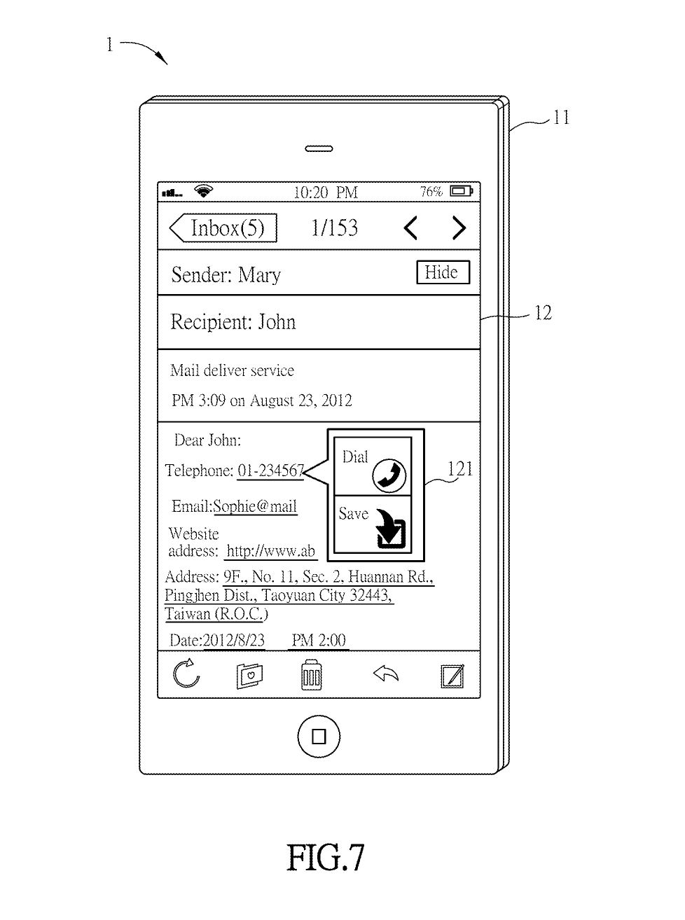

In another embodiment, the detected data structure to be selected is enabled for input (step S60), which may also be implemented by displaying the link instruction in a menu form. FIG. 7 is a schematic view showing a user interface of the hand-held electronic device of FIG. 1 according to another implementation. As shown in FIG. 7, the user may also touch the position corresponding to the telephone number on the touch-sensing cover 11. At this time, a menu 121 is firstly displayed, and icons of multiple options of multiple instruction contents, such as “dial (instruction)” and “save (instruction)”, are displayed on the menu 121, so that the user can further tap the subsequent operation. In other words, the detected data structure may be linked to multiple instructions. If the user taps the “dial” option icon, then the control unit 13 executes the instruction of making a phone call as mentioned hereinabove, to execute the application program making a phone call according to the telephone number. If the user taps the “save” option icon, then the control unit 13 executes the instruction of saving the telephone number to execute the application program of opening the phonebook, and enter the interface of saving the telephone number.

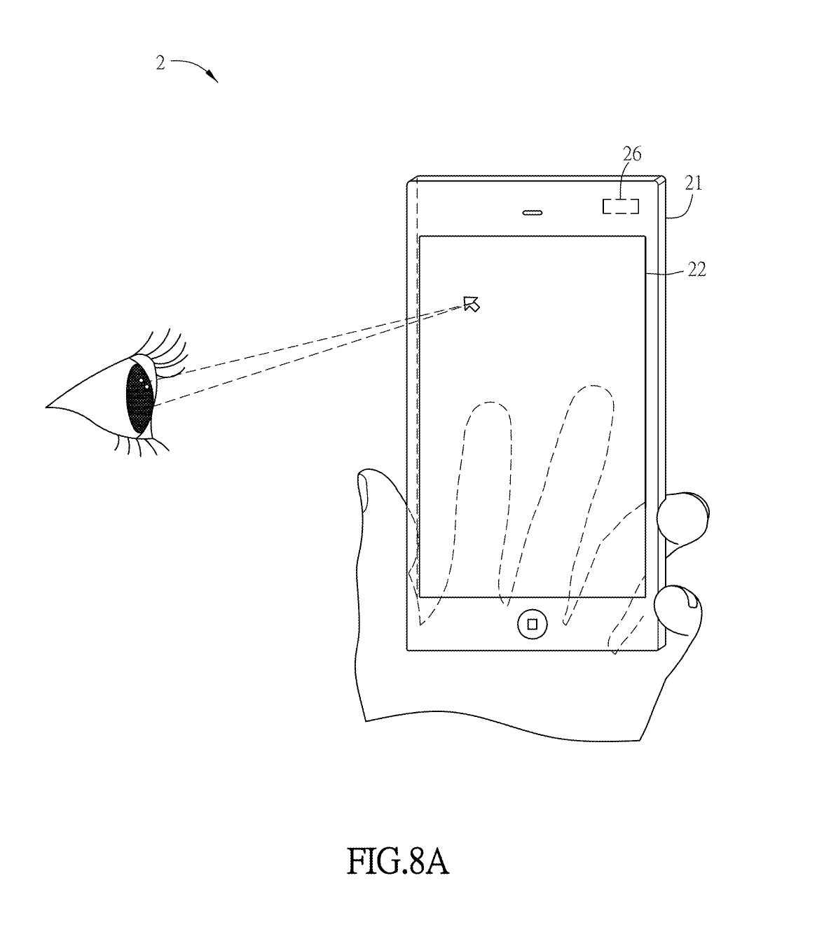

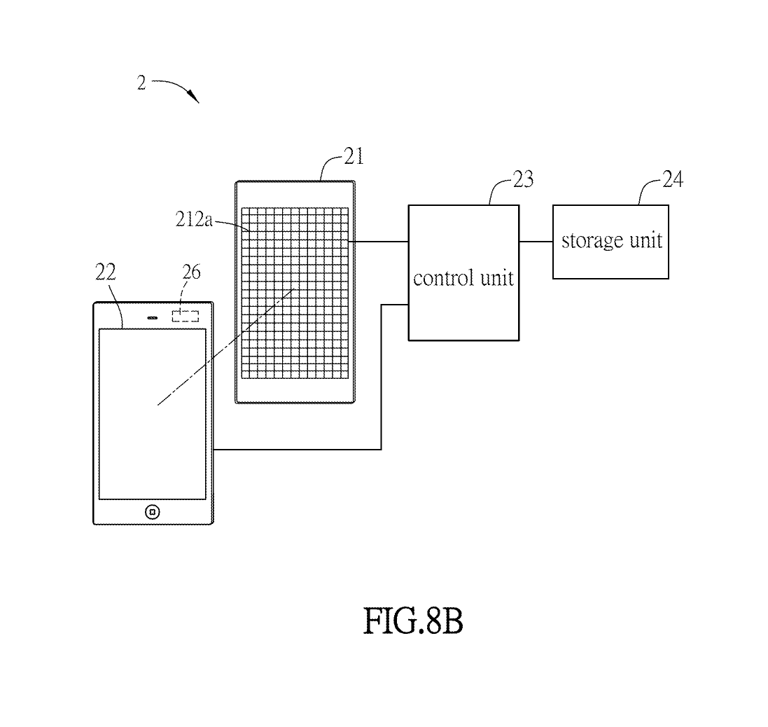

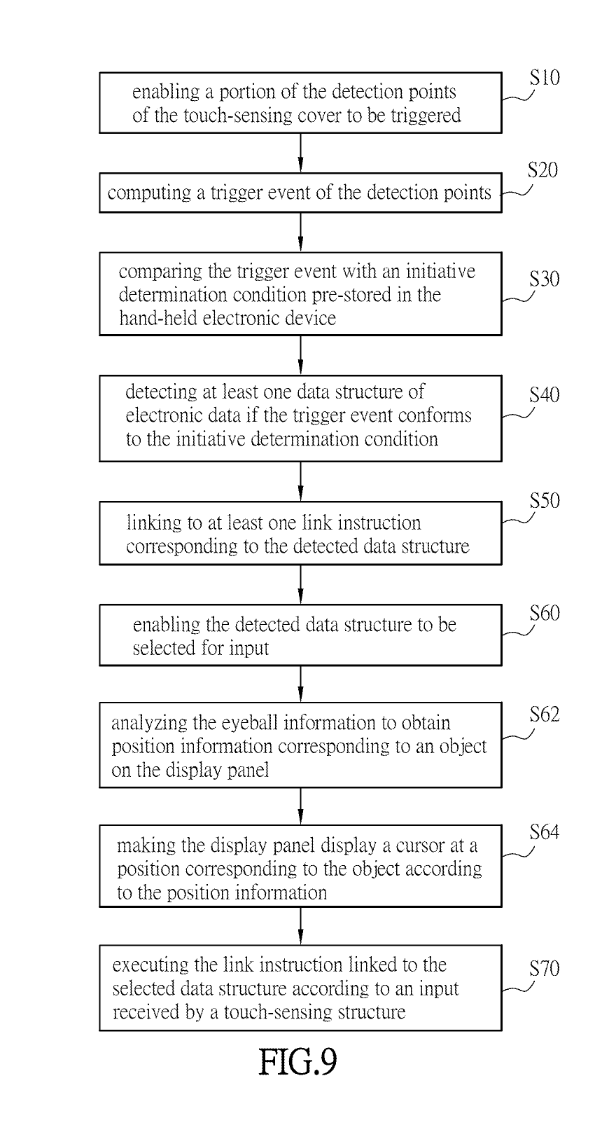

In another embodiment, the detected data structure to be selected is enabled for input (step S60), and the position being selected for input is not particularly restricted. FIGS. 8A and 8B are schematic views showing a shadeless touch hand-held electronic device according to a second embodiment of the invention. Referring to FIGS. 8A and 8B concurrently. A hand-held electronic device 2 of this embodiment further comprises an eyeball tracking module 26, which may be, for example but without limitation to, an eye tracker, a camera, a photographing device or an infrared detecting device for detecting the user's eyeball information. The eyeball tracking module 26 captures the eyeball information related to a display panel 22. That is, the eyeball tracking module 26 captures the user's eyeball information, which may be an eye image, eye coordinates or a combination thereof. The eyeball tracking module 26 is coupled to a control unit 23, so the control unit 23 can receive the eyeball information. FIG. 9 is a flow chart showing steps of a computer-executed method according to the second embodiment of the invention. Referring to FIG. 9, after receiving the eyeball information, the control unit 23 executes the steps of: analyzing the eyeball information to obtain the position information corresponding to the object on the display panel (step S62); and enabling the display panel to display a cursor at a position corresponding to the object according to the position information (step S64).

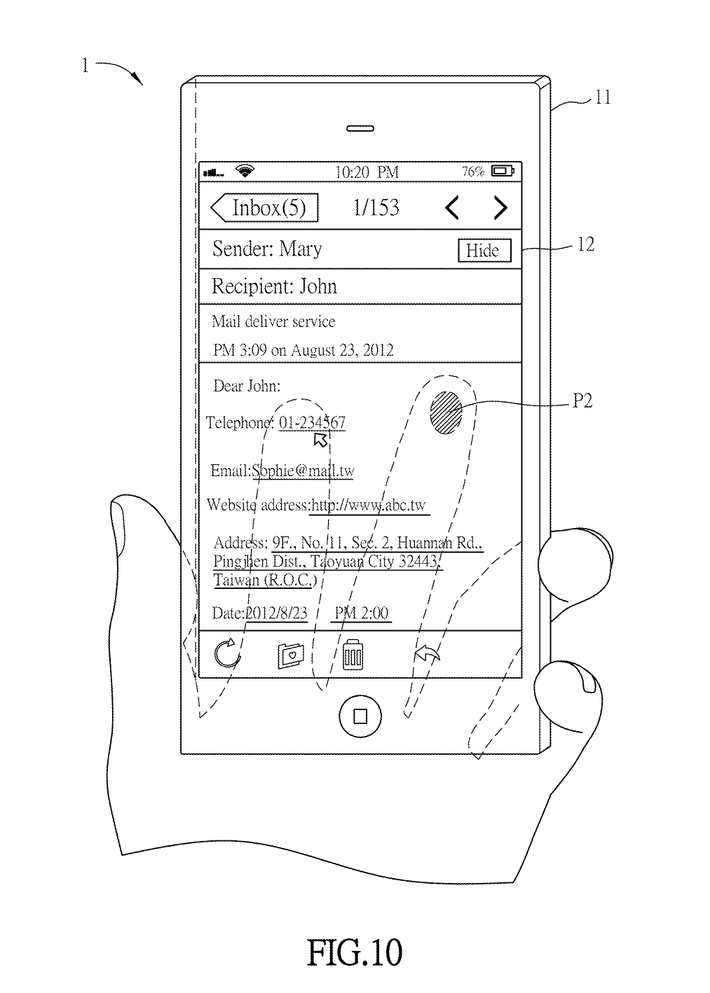

In details, the control unit 23 can analyze the eyeball information to determine the position on the display panel 22 where the user is looking at, and to obtain the position information on the display panel 12. FIG. 10 is a schematic view showing a user interface of the hand-held electronic device of FIG. 8A. Referring to FIG. 10, on step S62, the position information corresponds to at least one object on the display panel 22. In this embodiment, the object is the one detected as having the specific grammar or the predetermined string pattern, that is, the telephone number, address, date, time or the similar string displayed as shown in FIG. 10. Next, in step S64, the control unit 23 enables the display panel 22 to display the cursor at the position corresponding to the object according to the position information so that the user can understand the position currently corresponding to the position information. When the user's eyeball information fluctuates, the cursor (position information) on the display panel 22 is also correspondingly moved.

Thus, the user can move the arrow cursor to the specific grammar or the predetermined string pattern by looking at the specific grammar or the predetermined string pattern, and the user looks at the string of the telephone number in this example of this embodiment. Meanwhile, the control unit 23 can further enable a touch-sensing structure 212 to be selected for input, but the position to be selected for input is not particularly restricted. In other words, the user can perform the touch input on the touch-sensing structure 212 without restricting the touch position. In this embodiment, the user touches the position P2 of a touch-sensing cover 21 corresponding to the portion beside the telephone number, so that the control unit 23 can execute the link instruction linked to the corresponding data structure (i.e., the selected data structure) highlighted by the cursor according to the input (step S70).

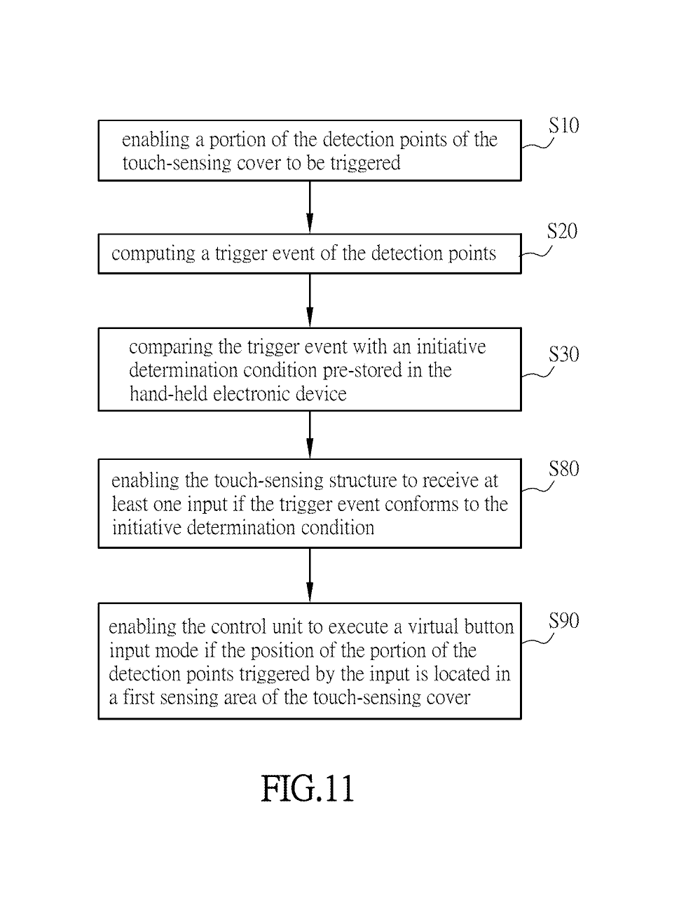

FIG. 11 is a flow chart showing steps of a computer-executed method according to a third embodiment of the invention. Referring to FIG. 11, the computer-executed method of this embodiment is stored in the storage unit 14 (see FIG. 2), and the control unit 13 executes the computer-executed method with the virtual button function of this embodiment. The computer-executed method of this embodiment enables the hand-held electronic device 1 to activate the virtual button function, and to execute the steps of: enabling a portion of the detection points of the touch-sensing cover to be triggered (step S10); computing a trigger event of the portion of the detection points (step S20); comparing the trigger event with the initiative determination condition pre-stored in the hand-held electronic device (or referred to another portable electronic device) (step S30); enabling the touch-sensing structure to receive at least one input if the trigger event conforms to the initiative determination condition (step S80); enabling the control unit to execute the virtual button input mode if the position of the portion of the detection points triggered by the input is located in the first sensing area of the touch-sensing cover.

If the trigger quantity distribution or trigger morphology conforms to the initiative determination condition, then the touch-sensing structure 112 receives at least one input (step S80). In other words, the control unit 13 only can execute the other operation under the precondition that the trigger quantity distribution or trigger morphology conforms to the initiative determination condition. In this embodiment, the control unit 13 enables the touch-sensing structure 112 to receive the other input (i.e., enables the detection point 112a to be triggered). Thus, only when the trigger quantity distribution or trigger morphology conforms to the initiative determination condition, the operation, such as button inputting, handwritten inputting or frame switching between the button input mode and the handwritten input mode, or the like, can be performed on the hand-held electronic device 1. Thus, when another user operates the hand-held electronic device 1, the operation of the hand-held electronic device 1 cannot be continued because the trigger quantity distribution or trigger morphology of the user is different from the initiative determination condition preset by the original user. Thus, the overall security of the hand-held electronic device 1 can be enhanced. Preferably, the control unit 13 can compute the trigger event of the detection point 112a with an interval in a predefined time, and compare the trigger event with the initiative determination condition to further enhance the security in using the hand-held electronic device 1.

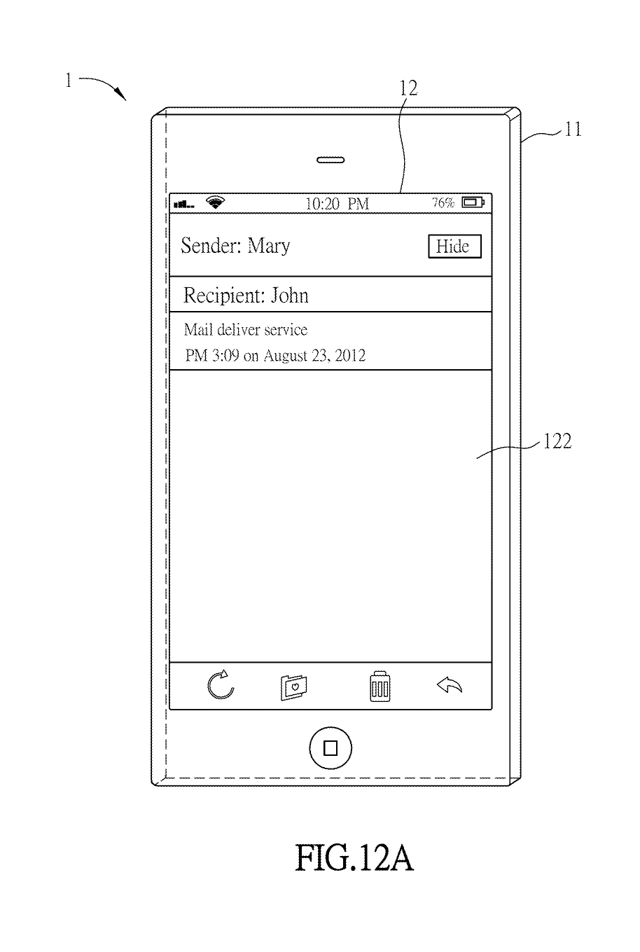

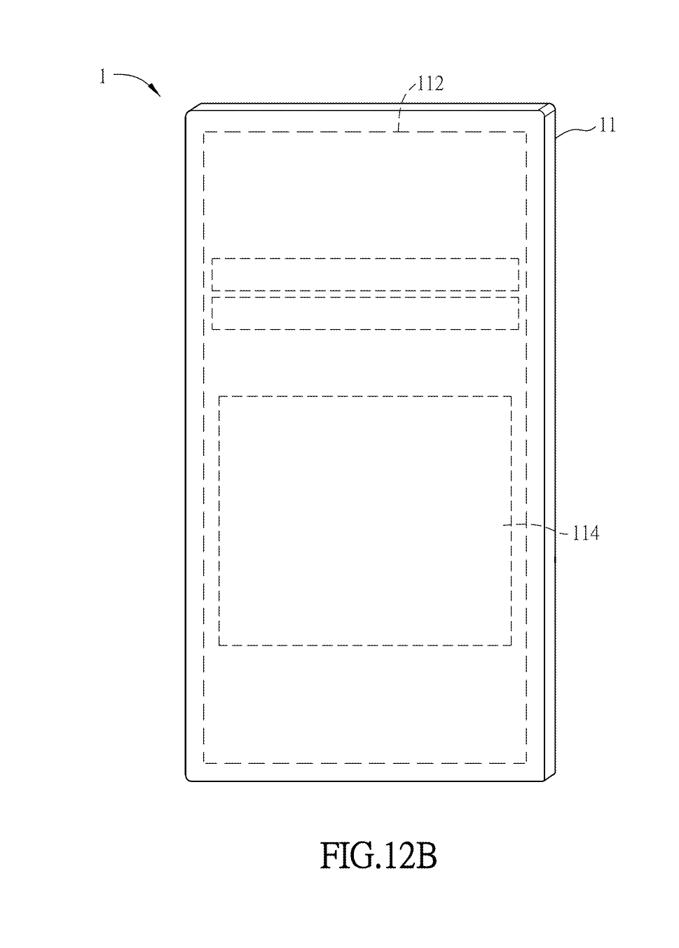

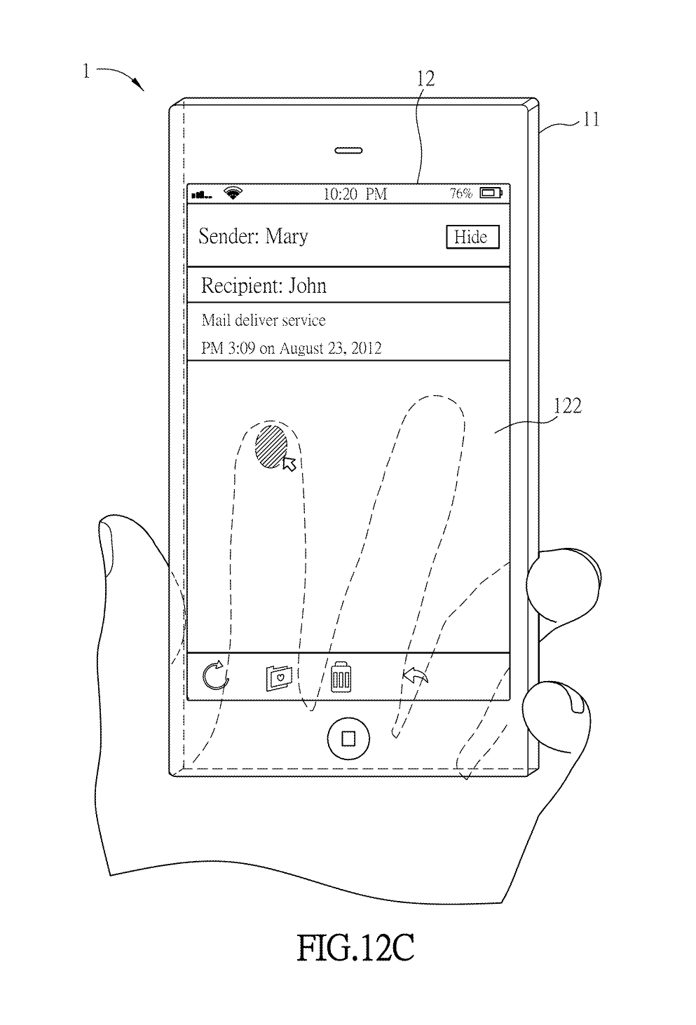

Next, the control unit 13 can execute the step S90 to execute the virtual button input mode. FIG. 12A is a schematic view showing a graphic user interface displayed by the hand-held electronic device according to the third embodiment of the invention. FIG. 12B is a schematic view showing the touch-sensing cover of FIG. 12A corresponding to the graphic user interface of FIG. 12A. Referring to FIGS. 2, 12A and 12B concurrently. In this embodiment to be described as an example, the hand-held electronic device 1 executes the e-mail program. Thus, the graphic user interface upon executing the e-mail program is displayed on the display panel 12 of FIG. 12A. In other embodiments, the short message, webpage browser or similar programs may also be executed, and it is not limited thereto. Meantime, the display panel 12 displays an icon 122 (see FIG. 12A). The touch-sensing cover 11 further comprises a first sensing area 114 (see FIG. 12B) at the position corresponding to the icon 122 (the position of the icon 122 of this embodiment is the region where the mail contents can be inputted). That is, the position of the touch-sensing structure 112 corresponding to the icon 122 may be defined as the first sensing area 114, so the detection point 112a is distributed in the first sensing area 114.

When the user holds the hand-held electronic device 1, the user's finger may touch the first sensing area 114, as shown in FIG. 12C. FIG. 12C is a schematic view showing the operation of the hand-held electronic device of FIG. 12A. As shown in FIG. 2, the signal generated by the detection point 112a may be transmitted to the control unit 13, which can determine that the signal comes from the first sensing area 114, and thus execute the virtual button mode. In detail, the icon 122 is a functional icon having the instruction of enabling the control unit 13 of the hand-held electronic device 1 to execute the virtual button mode. When the user touches the first sensing area 114 on the touch-sensing cover 11 (i.e., when the first sensing area 114 receives the input, or when the icon 122 corresponding to the position of the touch-sensing cover 11) is touched, the touch-sensing structure 112 of the first sensing area 114 generates the capacitance change, and then generates and transmits the corresponding signal to the control unit 13, so that the control unit 13 accordingly executes the instruction of the virtual button input mode.

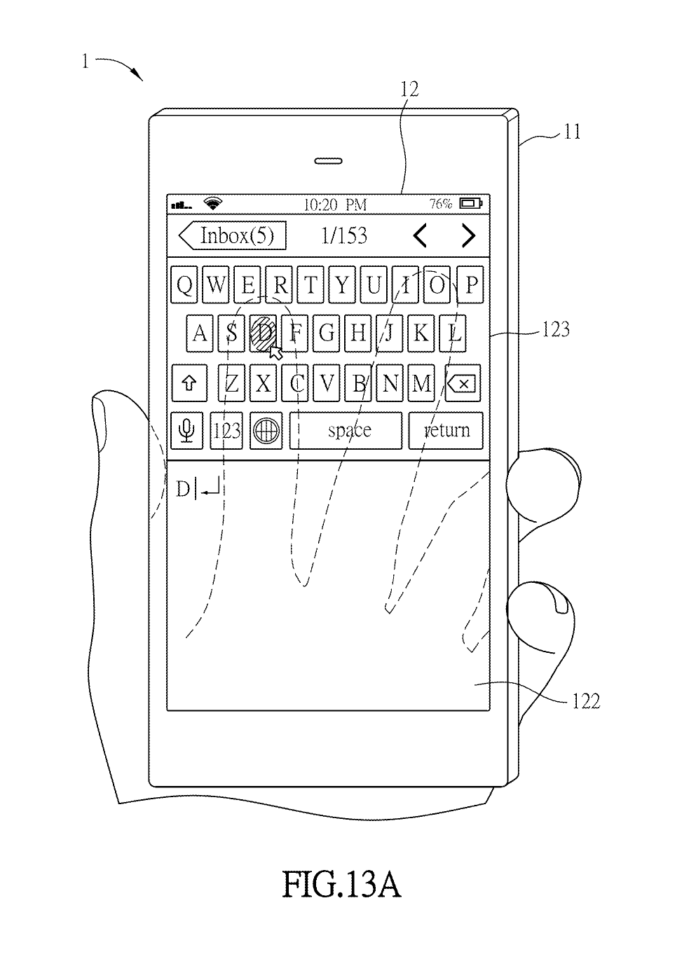

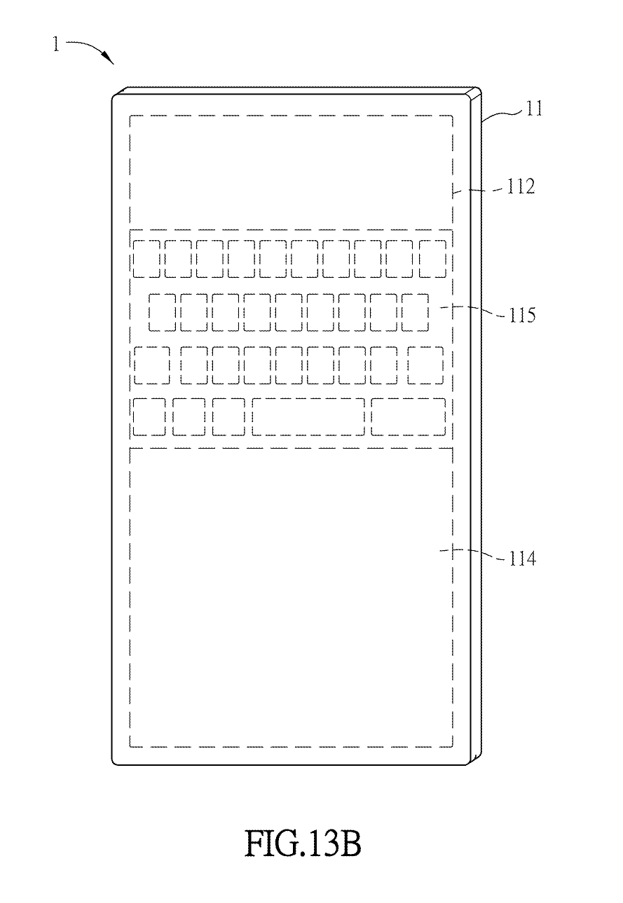

The virtual button input mode of this embodiment comprises enabling the display panel 12 to display a virtual keyboard 123, as shown in FIG. 13A, and enabling the touch-sensing structure 112 to generate a second sensing area 115. The second sensing area 115 corresponds to the virtual keyboard 123 displayed on the display panel 12, as shown in FIG. 13B. FIG. 13A is a schematic view showing a graphic user interface displayed on the display panel according to the third embodiment. FIG. 13B is a schematic view showing the touch-sensing cover of FIG. 13A corresponding to the graphic user interface. Referring to FIG. 2, a portion of the detection points 112a is also distributed in the second sensing area 115. It is to be noted that for the sake of clearly depicting the drawings, what is viewed from FIG. 12B is at the viewing angle in the direction from the display panel 12 to the touch-sensing cover 11, and the structure of the display panel 12 is omitted, but is not at the view angle after the touch-sensing cover 11 is inverted.

To sum up, the user can enable the control unit 13 to display the virtual keyboard 123 on the display panel 12 through the input of touching the first sensing area 114 corresponding to the icon 122, and enable the touch-sensing structure 112 to generate the second sensing area 115 in correspondence to the virtual keyboard 123, so that the user can input the information by tapping each button of the virtual keyboard 123. It is to be noted that in order to facilitate the operation convenience of the user in operating the touch-sensing cover 11, the virtual keyboard is located above the touch-sensing cover 11 in the button input mode of this embodiment, as shown in FIG. 13B.

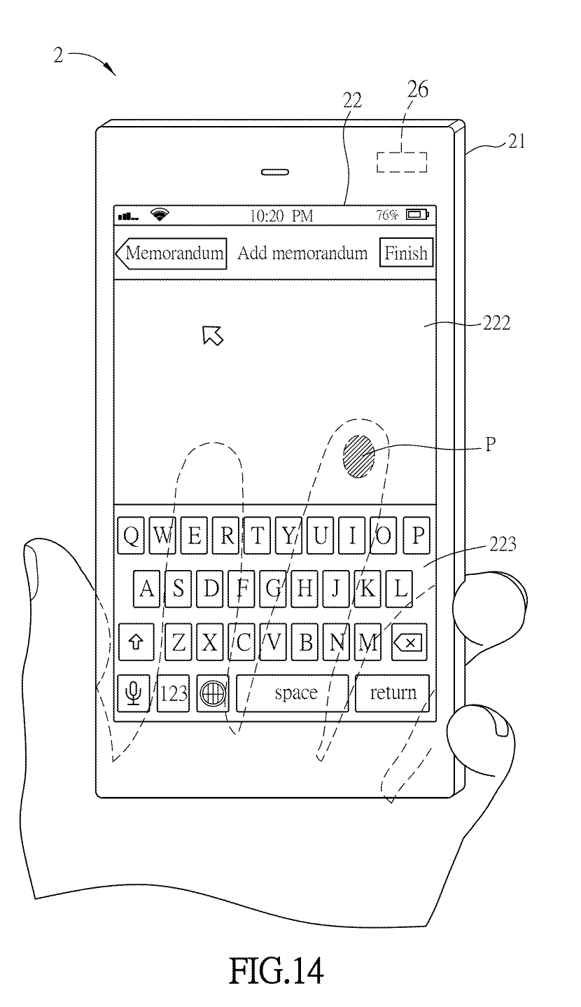

In another embodiment, the switching between the button input mode and the handwritten input mode may also be achieved by way of eyeball tracking. This embodiment may be described with reference to FIGS. 8A and 8B, the hand-held electronic device 2 of this embodiment has an eyeball tracking module 26, the details of which may be found in the second embodiment. The eyeball tracking module 26 acquires the eyeball information related to the display panel 22 (i.e., the user's eyeball information), and the control unit 23 can receive the eyeball information. Next, the control unit 23 can analyze the eyeball information to obtain the position information, and enable the display panel 22 to display the cursor according to the position information, as shown in FIG. 14. FIG. 14 is a schematic view showing a user interface of a shadeless touch hand-held electronic device according to a fourth embodiment of the invention. In details, the control unit 23 can analyze the eyeball information to determine the position where the user looks at the display panel 22, and to obtain the position information of the display panel 22. The control unit 23 can thus enable the display panel 22 to display the cursor at the position corresponding to the object according to the position information, as depicted by an icon 221 of FIG. 14, so that the user understands the current position corresponding to the position information. When the user's eyeball information fluctuates, the cursor (position information) on the display panel 22 is also correspondingly moved.

Meanwhile, the control unit 23 may also enable the touch-sensing structure 212 to receive the input, but the position to be selected for input is not particularly restricted. In other words, the user can perform the touch input through the touch-sensing structure 212, and the touch position is not restricted. In this embodiment, the position P of the touch-sensing cover 21 corresponding to the displays information field is touched, and thus the control unit 23 can execute the virtual button input mode according to the input.

In summary, in the hand-held electronic device and the computer-executed method, the user can operate, on the touch-sensing cover, the user interface displayed on the display panel, and the method comprises: computing the trigger event of a portion of the detection points; comparing the trigger event with the initiative determination condition pre-stored in the hand-held electronic device; detecting at least one data structure of electronic data if the trigger event conforms to the initiative determination condition; linking to at least one link instruction corresponding to the detected data structure; enabling the detected data structure to be selected for input; and executing the link instruction linked to the selected data structure according to the input received by the touch-sensing structure. The detected data structure has the specific grammar or string. Therefore, the user can perform the operation on the touch-sensing cover of the hand-held electronic device, so the finger cannot shade the user's view, the software objects on screen or the information displayed according to the electronic data, and the link of the high information density content, which can link to the associated instruction, cannot be inadvertently touched. In addition, because the electronic device needs not to be operated on the display panel, the panel scratching can be decreased. In addition, the data structure of electronic data is detected and the detected data structure is linked to its corresponding instruction. Thus, when the user touches the information contents displayed in correspondence to the data structure on the touch-sensing cover, the corresponding instruction can be executed concurrently to generate the corresponding operation, thereby creating the smart hand-held electronic device, which truly fits the user.

Furthermore, the display panel of the hand-held electronic device displays the icon, and the touch-sensing structure of the touch-sensing cover is also defined with the first sensing area corresponding to the icon, so that the user can directly perform the operation on the touch-sensing cover of the hand-held electronic device. That is, the user can touch the first sensing area to enable the control unit to execute the virtual button input mode, and thus further operate the button for input on the touch-sensing cover. Therefore, the finger cannot shade the user's view, the screen software objects or the information displayed according to the electronic data, and the link of the high information density content, which can link to the associated instruction, cannot be inadvertently touched. In addition, because the electronic device needs not to be operated on the display panel, the panel scratching can be decreased.

Moreover, when the user uses the hand-held electronic device under the sun, the user can use one hand to operate the hand-held electronic device with the touch-sensing cover blocking the sunlight or light source. Because the touch-sensing cover blocks the sunlight, the information of the display panel can be clearly read, and the sunlight readability of the display panel can be improved. In addition, new technology of the OLED or electronic paper display panel is not necessary, and the user can use one hand to perform the operation or input on the information of the display panel through the touch-sensing cover. In addition, the security in operating the hand-held electronic device and the single-hand operation convenience under the sunlight can be enhanced.

In addition, the hand-held electronic device can execute the other operation only under the precondition that the trigger quantity distribution or trigger morphology conforms to the initiative determination condition. Thus, when another user operates the hand-held electronic device, the operation of the hand-held electronic device cannot be continued because the trigger quantity distribution or trigger morphology is not consistent with that of the initiative determination condition preset by the original user. Thus, the overall security of the hand-held electronic device is enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shadeless touch hand-held electronic device, capable of detecting data structure of electronic data stored in the hand-held electronic device and generating a corresponding link instruction, the hand-held electronic device comprising:
a touch-sensing cover, comprising:
a cover; and
a touch-sensing structure, having a plurality of detection points to be triggered, wherein partial or total area of the touch-sensing structure is disposed on the cover; and
a display panel, displaying information corresponding to the electronic data; and
a control unit, coupled to the touch-sensing cover and the display panel, and executing following steps of:
computing a trigger event of the detection points;
comparing the trigger event with an initiative determination condition pre-stored in the hand-held electronic device;
detecting at least one data structure of electronic data if the trigger event conforms to the initiative determination condition;
linking to at least one link instruction corresponding to the data structure;
enabling the detected data structure to be selected for input; and
executing the link instruction linked to the selected data structure according to an input received by the touch-sensing structure.

2. The hand-held electronic device of claim 1, wherein the trigger event comprises a trigger quantity, a trigger quantity distribution, a trigger morphology, a trigger time, a trigger frequency or a trigger location.

3. The hand-held electronic device of claim 1, wherein the control unit computes the trigger event of the detection points with an interval in a predefined time, and compares the trigger event with the initiative determination condition pre-stored in the hand-held electronic device.

4. The hand-held electronic device of claim 1, wherein the control unit computes another trigger event generated by the input triggering the detection points, and compares another trigger event with an executive determination condition pre-stored in the hand-held electronic device.

5. The hand-held electronic device of claim 1, wherein the area of the touch-sensing structure and the area of the display panel have a ratio relationship.

6. The hand-held electronic device of claim 1, wherein the touch-sensing cover is disposed on the side of the hand-held electronic device opposite the panel.

7. The hand-held electronic device of claim 1, wherein the touch-sensing structure comprises metal mesh, metal nanowires, transparent conducting film, carbon nanotube or graphene.

8. The hand-held electronic device of claim 1, wherein the control unit analyzes a grammar of the electronic data, compares the electronic data with grammars pre-stored in the hand-held electronic device, and detects the data structure of the electronic data having at least one of the grammars.

9. The hand-held electronic device of claim 1, wherein the control unit analyzes a string of the electronic data, compares the electronic data with predetermined string patterns pre-stored in the hand-held electronic device, and detects the data structure of the electronic data having at least one of the predetermined string patterns.

10. The hand-held electronic device of claim 1, wherein contents of the link instruction are displayed on the display panel in a menu form.

11. The hand-held electronic device of claim 1, further comprising:
an eyeball tracking module, acquiring eyeball information corresponding to the display panel.

12. The hand-held electronic device of claim 11, wherein the control unit is coupled to the eyeball tracking module, receives the eyeball information and executes the steps of:
analyzing the eyeball information to obtain position information corresponding to an object on the display panel; and
making the display panel display a cursor at a position corresponding to the object according to the position information.

13. The hand-held electronic device of claim 12, wherein a user uses one hand to operate the hand-held electronic device, and takes the touch-sensing cover to face a light source or take the back of the panel to face the light source.

14. A computer-executed method capable of detecting a data structure of electronic data and generating a corresponding link instruction, and executed on a hand-held electronic device, wherein the hand-held electronic device comprises a display panel and a touch-sensing cover, and the touch-sensing cover has a plurality of detection points, the method comprising following steps of:
enabling a portion of the detection points of the touch-sensing cover to be triggered;
computing a trigger event of the detection points;
comparing the trigger event with an initiative determination condition pre-stored in the hand-held electronic device;
detecting at least one data structure of electronic data if the trigger event conforms to the initiative determination condition;
linking to at least one link instruction corresponding to the detected data structure;
enabling the detected data structure to be selected for input; and
executing the link instruction linked to the selected data structure according to an input received by a touch-sensing structure.

15. A shadeless touch hand-held electronic device with a virtual button function, comprising:
a display panel, displaying an icon; and
a touch-sensing cover, comprising:
a cover, disposed on the side of the hand-held electronic device opposite the display panel; and
a touch-sensing structure, disposed on the cover and receiving at least one input, and comprises a first sensing area and a plurality of detection points, wherein the first sensing area corresponds to the icon on the display panel, and some of the detection points are distributed in the first sensing area; and
a control unit coupled to the touch-sensing structure, wherein the control unit computes a trigger event of the detection points, and compares the trigger event with an initiative determination condition pre-stored in the hand-held electronic device, wherein if the trigger event conforms to the initiative determination condition, the touch-sensing structure receives at least one input, and positions of some of the detection points triggered by the input are located in the first sensing area, then the control unit executes a virtual button input mode.

16. The hand-held electronic device of claim 15, wherein the trigger event comprises a trigger quantity, a trigger quantity distribution, a trigger morphology, a trigger time, a trigger frequency or a trigger location.

17. The hand-held electronic device of claim 15, wherein the control unit computes the trigger event of the detection points with an interval in a predefined time, and compares the trigger event with the initiative determination condition pre-stored in the hand-held electronic device.

18. The hand-held electronic device of claim 15, wherein the virtual button input mode comprises: making the display panel display a virtual keyboard, and making the touch-sensing structure generate a second sensing area corresponding to the virtual keyboard on the display panel, wherein some of the detection points are distributed in the second sensing area.

19. The hand-held electronic device of claim 15, further comprising:
an eyeball tracking module acquiring eyeball information corresponding to the display panel.

20. The hand-held electronic device of claim 19, wherein the control unit is coupled to the eyeball tracking module, and the control unit receives the eyeball information, analyzes the eyeball information to obtain position information, makes the display panel display a cursor according to the position information, and makes the touch-sensing structure receive the input operation.
